(19) United States
(12) Patent Application Publication
(10) Pub. No.: US 2014/0306987 A1
(43) Pub. Date: Oct. 16, 2014

(54) Methods and Systems for Visualizing and Ranking Connected Media Content

(71) Applicant: SNIBBE INTERACTIVE, INC., San Francisco, CA (US)

(72) Inventors: Scott SNIBBE, San Francisco, CA (US); Alan SHIMOIDE, San Francisco, CA (US)

(73) Assignee: SNIBBE INTERACTIVE, INC., San Francisco, CA (US)

(21) Appl. No.: 14/096,985

(22) Filed: Dec. 4, 2013

Related U.S. Application Data
(60) Provisional application No. 61/810,904, filed on Apr. 11, 2013.

(51) Int. Cl. G06T 11/20

(52) U.S. Cl. CPC G06T 11/206
USPC 345/619

(57) ABSTRACT

A novel form of visualizing and viewing media in text, image, audio, and video format is introduced in which media with interconnected relationships benefit from visualizing and ranking techniques and systems. A method can include organizing media stored on a plurality of nodes, the media being contextually connected based on time, story, character, or other criteria derived automatically through metadata and/or analysis, or generated manually by content creators or users. The method can also include generating one or more images of the nodes based on at least one parameter related to a user. The image(s) of the nodes can illustrate connections between the nodes, and can be generated based on datasets selected by the user, a desired level of detail selected by the user, or a prioritized set of nodes most relevant to the user. The nodes can provide links to view and watch media in text, image, and video format, and can be augmented by social commentary, connection, sharing, and e-commerce.

### CROSS-REFERENCE TO RELATED APPLICATION

This application is related to and claims the benefit and priority of U.S. Provisional Patent Application No. 61/810,904, filed on Apr. 11, 2013, which is hereby incorporated herein by reference in its entirety.

### BACKGROUND

1. Field

Media with interconnected relationships may benefit from visualizing and ranking techniques and systems. More specifically, interconnected media associated with nodes may benefit from being viewable based on certain user information.

2. Description of the Related Art

Interconnected media can be represented in various forms. Examples of interconnected media can be media with storylines that have been divided into video, text, graphic, or audio episodes. Each episode can be represented as a node in a graph or pictorial representations in a cover flow form. The storylines and the characters can be viewed on a semantic graph with the character connections from episode to episode represented as connections in a semantic graph with nodes displayed sequentially.

The media can be considered contextually connected when the interconnections are interconnections, such as temporal relationships. For example, media that is connected by a storyline in real or fictional time can be considered contextually connected.

The difficulty of browsing interconnected media on a semantic graph is that as the number of graph nodes increases and as the connectivity of the graph nodes increases, the visual complexity of the graph will also increase. Such information density can be appreciated by some, however, it may be overwhelming to others. Even one that may appreciate a high information density presentation may need to focus on a particular section of a graph while continuing to visualize the overall relationship to the entire graph. A simple culling of nodes could remove nodes that are critical to maintaining the contextual relationship, such as an episode that deals with a traumatic injury to a character.

It may also be worthwhile to take into account what is currently relevant to a user, since the interests of users may shift depending on what related movies, games, theme park attractions, cartoons, television shows, characters, stars, or other entertainment is currently trending.

### SUMMARY

According to certain embodiments of the present invention, a method can include organizing media stored on a plurality of nodes, the media being contextually connected. The method can also include generating one or more images of the nodes based on at least one parameter related to a user. The method can further include providing the one or more images of the nodes to at least one display. The one or more images of the nodes to be displayed can illustrate connections between the displayed nodes. The one or more images of the nodes can be generated based on datasets selected by the user, a desired level of detail selected by the user, or a prioritized set of nodes that are most relevant to the user.

In certain embodiments of the present invention, an apparatus can include at least one processor and at least one memory including computer program code. The at least one memory and the computer program code can be configured to, with the at least one processor, cause the apparatus at least to generate one or more images of the nodes based on at least one parameter related to a user. The at least one memory and the computer program code can also be configured to, with the at least one processor, cause the apparatus at least to provide the one or more images of the nodes to at least one display. The one or more images of the nodes to be displayed may illustrate connections between the displayed nodes. The one or more images of the nodes can be generated based on datasets selected by the user, a desired level of detail selected by the user, or a prioritized set of nodes that are most relevant to the user.

A non-transitory computer-readable medium can, in certain embodiments of the present invention, be encoded with instructions that, when executed in hardware, perform a process. The process can include organizing media stored on a plurality of nodes, and the media may be contextually connected. The process can also include generating one or more images of the nodes based on at least one parameter related to a user. The process can further include providing the one or more images of the nodes to at least one display. The one or more images of the nodes to be displayed can illustrate connections between the displayed nodes. The one or more images of the nodes can be generated based on datasets selected by the user, a desired level of detail selected by the user, or a prioritized set of nodes that are most relevant to the user.

An apparatus can, according to certain embodiments of the present invention, include means for organizing media stored on a plurality of nodes, and the media may be contextually connected. The apparatus can also include means for generating one or more images of the nodes based on at least one parameter related to a user. The apparatus can further include means for providing the one or more images of the nodes to at least one display. The one or more images of the nodes to be displayed can illustrate connections between the displayed nodes. The one or more images of the nodes can be generated based on datasets selected by the user, a desired level of detail selected by the user, or a prioritized set of nodes that are most relevant to the user.

### BRIEF DESCRIPTION OF THE DRAWINGS

For proper understanding of the invention, reference should be made to the accompanying drawings, wherein:

FIG. 1 illustrates a block diagram of a system of servers supplying custom views of a semantic graph to a graph visualization community according to certain embodiments of the present invention.

FIG. 2 illustrates a block diagram of a graph node and other connected nodes according to certain embodiments of the present invention.

FIG. 3 illustrates a block diagram of components for calculating a node visualization weight according to certain embodiments of the present invention.

FIG. 4 illustrates a block diagram of a system for ranking and visualizing media organized into a semantic graph at various levels of detail for a user according to certain embodiments of the present invention.

FIG. 5 illustrates a method for ranking and visualizing connected media content according to certain embodiments of the present invention.

FIG. 6 illustrates an apparatus for ranking and visualizing connected media content according to certain embodiments of the present invention.

FIG. 7 illustrates an exemplary implementation of certain embodiments of the present invention in a two-dimensional view of a node graph view.

FIG. 8 illustrates an exemplary implementation of certain embodiments of the present invention in a three-dimensional “ride” view of the node graph that simplifies viewing for users as one node at a time.

FIG. 9 illustrates an exemplary implementation of certain embodiments of the present invention as in FIG. 8 with simplified user choices for navigating the graph.

FIG. 10 illustrates another exemplary implementation of certain embodiments of the present invention as in FIG. 8 with simplified user choices for navigating the graph.

FIG. 11 illustrates an exemplary implementation of certain embodiments of the present invention as in FIG. 7 with a view of the user's profile.

FIG. 12 illustrates an exemplary implementation of certain embodiments of the present invention as in FIG. 7 in which the user achieves a reward based on exploration or participation.

FIG. 13 illustrates an exemplary implementation of certain embodiments of the present invention as in FIG. 7 in which the user purchases media items, subscriptions, or virtual currency to buy media.

FIG. 14 illustrates another exemplary implementation of certain embodiments of the present invention as in FIG. 7 in which the user purchases media items, subscriptions, or virtual currency to buy media.

FIG. 15 illustrates an exemplary implementation of certain embodiments of the present invention as in FIG. 7 in which the user receives notifications of social activity associated with nodes, and shares content with external social networks.

FIG. 16 illustrates another exemplary implementation of certain embodiments of the present invention as in FIG. 7 in which the user receives notifications of social activity associated with nodes, and shares content with external social networks.

FIG. 17 illustrates an exemplary implementation of certain embodiments of the present invention as in FIG. 7 in which users can engage in social conversations with other users associated with nodes, and share content with external social networks.

### DETAILED DESCRIPTION

Contextually connected media can be visualized and organized into semantic graphs, at varying levels of complexity such that the contextual relations of the media are visually highlighted at a plurality of, if not all, levels of detail. The visualization can be dynamically customized for each user. The system can dynamically generate visualizations that are customized to the user-selected datasets, the desired level of complexity, and/or to the profile of the user based on the user's similarity to other users.

This system can alter the visualization of the semantic graph dynamically and reduce or add connected media, represented as nodes and their connections, to the visualization depending on the desired level of complexity and a prioritized set of nodes that are most relevant for each user. A novice user can have a custom simplified view that primarily displays key nodes and/or nodes that are popular to novice users. Expert or more experienced users can have a custom complex view of the graph that displays greater complexity as well as nodes that may be key branching points with many other node connections. The system can select nodes to display at each level of complexity such that the displayed nodes are representative of the context of the media, the importance of the node relative to other displayed nodes, the relevancy of the node to the user, the importance of the node within a community of visualization users, and/or the importance of the node based on metrics representing popularity from other data sources. The system can also dynamically weigh the nodes of a semantic graph such that the nodes can be visualized at various levels of detail. The visible nodes can be the most relevant nodes for the connected media. The system can also select nodes for visualization based on a dynamic weighting system, which may assign a weight to a node based on the context, importance, and/or popularity of the node.

As mentioned above, media content can be visualized and organized into semantic graphs, which may be customized for each user at various levels of detail. A system for providing such display of information can include of a system of servers and of devices or computers that may visualize the media content contained in the graph nodes. The media content can be audio, video, and/or text and can represent events, episodes, scenes, shots, digital representations of print media, locations, persons, personas, actors, characters, back-story, “making-of,” alternate storylines, and/or digital representations of physical objects, and the like. The system of servers can store the semantic graph, store the user database, calculate a dynamic node visualization weight for each user, calculate the appropriate node set for the user based on the weight and level of detail, store viewing metrics for the user, store metrics from other users, serve a social forum for each node, and/or serve the content of the nodes to the visualization users that form a community. The system of servers can also collect metrics to create profiles of a user's visualization(s), which can include metrics from a user's node viewing and metrics from a user's node related to the user's social activity, to rank nodes for viewing.

Devices and computers can be used by users of visualization software or of a visualization website to visualize the media that is organized into a semantic graph. Users can login to the system of servers through software on the devices and computers or through a web page. Devices and computers can communicate with the system of servers through a defined set of web-services. The software or the web page, viewed on the devices or computers, can animate the visualization of the graph to gradually reveal details of the graph as the user explores the connected media. The system of servers can stream the shape of the graph in two- or three-dimensions as well as a customized node set for each user and the associated media content. Users can explore the interconnections of media based on metadata relationships by adding or subtracting additional media characteristics such as categories, themes, imagery, characters, storyline, artists, and/or directors. Users can explore the interconnections of media and media characteristics at various levels of detail by exploring node sets that may be customized by the system of servers for each user.

Users of the visualization software or website may be able to participate in a community that comments, ranks, and socializes with other users around the media content in each node. Users can also earn status and achievements for participation in the community as an incentive to further participate in the community. Achievement and status can be used to unlock locked media or to gain special privileges within the community, such as the ability to edit metadata or the ability to mediate, moderate, and/or administer forums.

The system of servers can profile each user as they browse the visualization, stream media, and/or participate in the community to match user behavior with appropriate sets of nodes for visualization. The system of servers can also combine the metrics of the media collected from the individual user, community, and outside sources with the importance of a node in maintaining the media context to present a targeted subset of nodes to each user.

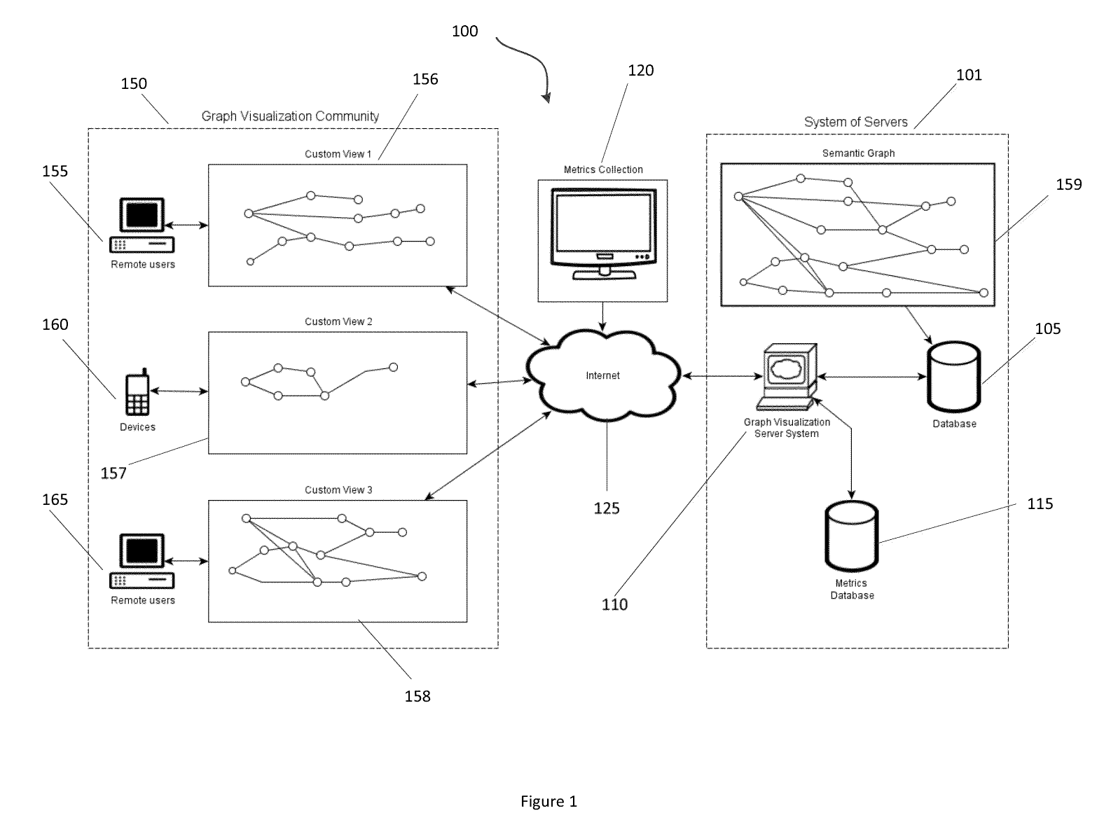

FIG. 1 illustrates a block diagram 100 that describes a system of servers 101 for dynamically supporting custom views 156-158 of a semantic graph 159 to a community 150 of users 155, 160, 165 visualizing the data by accessing the system of servers 101 through the Internet 125 according to certain embodiments of the present invention. The system of servers 101 can support the browsing of this semantic graph and associated content by multiple users 155, 160, 165 on multiple devices using service-oriented architecture. The system of servers 101 can include a database 105 that stores the semantic graph 159, which may be accessible to a graph visualization server system 110.

The visualization users 155, 160, 165 can be grouped into a community 150 within this browsing experience by attaching a system of logins, rating, commenting, questions, feedback, and/or profiles, etc. to the nodes and associated media. Metrics of browsing graph visualization behavior can be collected from the community via a metrics collection unit 120 and can be combined with metrics of viewing associated media from other sources, such as television or web, and combined in a database. The metrics obtained by the metrics collection unit 120 can be sent to the system of servers 101 via the Internet 125. From the Internet 125, the metrics obtained can be sent to a metrics database 115 via the graph visualization server system 110.

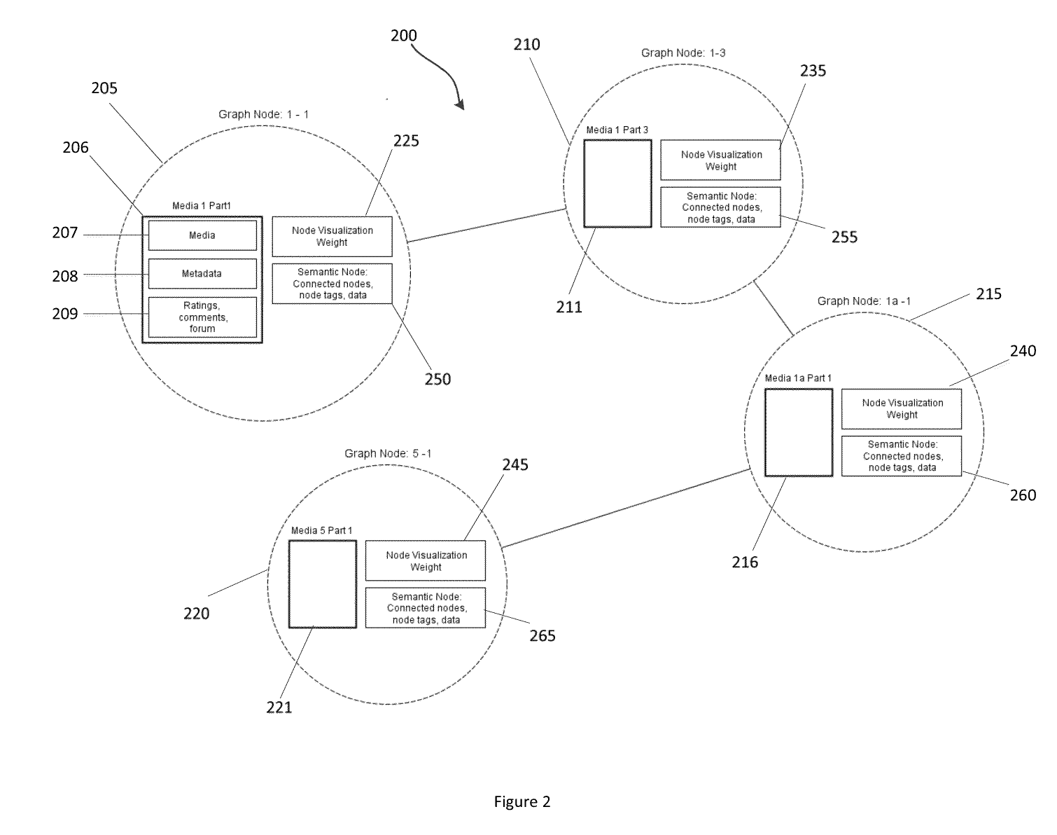

FIG. 2 illustrates a block diagram 200 of graph nodes 205, 210, 215, 220 and their associated media components 206, 211, 216, 221, respectively according to certain embodiments of the present invention. Media 207 can be audio, visual, and/or textual and can be organized into a semantic graph by characteristics such as: categories, themes, imagery, media type, characters, storyline, artists, writers, contributors, creators, directors, producers, actors, and/or personas. Users of the graph visualization system can select media organizing characteristics to view the interconnections of the media characteristics and their related media. Users can also view or listen to media 207 that can be divided into segments, units, events, or episodes by choosing a node 205, 210, 215, 220. The nodes 205, 210, 215, 220 can be displayed in a sequence that correlates to time, distance, or to a progression of the segments, units, events, or episodes of media.

Media components 206, 211, 216, 221 can be attached to graph nodes 205, 210, 215, 220 along with associated metadata 208 and social features 209 for each media component 206, 211, 216, 221 such as ratings, comments, and forums. Nodes 205, 210, 215, 220 can also contain a dynamically calculated visualization weight 225, 235, 240, 245 that may determine which nodes may be visible to a user at their desired level of detail. Nodes for display can be selected based on the calculated visualization weight 225, 235, 240, 245, the current level of visualization detail selected by the user, and what other media organizing characteristics were selected by the user. The nodes 205, 210, 215, 220 can also include semantic information 250, 255, 260, 265 that can identify the specific connections between the nodes, such as, for example, which nodes may be connected to each other. The semantic information 250, 255, 260, 265 can also include tag data and identifying information associated with each node 205, 210, 215, 220 based on the content contained within them.

Users can select other media organizing characteristics to add or subtract media segments that may be displayed. In FIG. 2, a user has selected media organizing characteristics, such as storyline 1 and storyline 5 to see their interconnections. The user will have the ability to either zoom into a few select nodes or to zoom out and see several more nodes and their connections. The figure shows that storylines 1 and 5 are connected through storyline 1a part 1 which can be an alternate storyline that is related to storyline 1. Users can add additional media organizing characteristics and see how they also connect to storyline 1 and storyline 5.

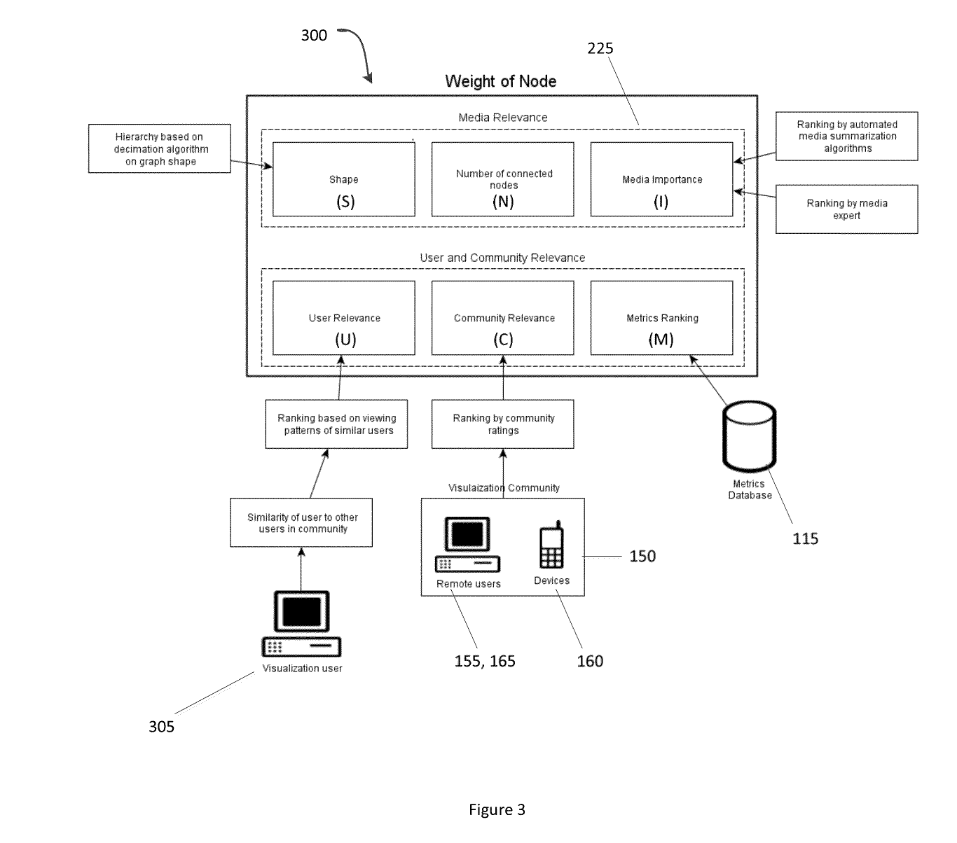

FIG. 3 illustrates a block diagram 300 that describes the components for calculating a visualization weight 225 for a node according to certain embodiments of the present invention. The visualization weight 225 for a node can determine whether a node is visible or not for a particular user and their chosen level of detail. Nodes with a greater weight can be visible to a user, while nodes with a lower weight may only be visible as the level of detail is increased in the visualization.

The weight of a node can be unique for each user. The visualization weight of a node (Wt) can be calculated based on the importance of the node in maintaining the relationships of connected media and the importance of the node to the user and the user community. The importance of the node to other connected media can be captured by the shape of the graph (S), the number of connected nodes (N), and a manual or algorithmically-assigned level of contextual importance to the node (I). The importance of the node to visualization users and the community can be captured by the relevancy of a node to a user (U), a visualization community importance to the node (C), and a metrics-based importance to the node, which may include metrics from sources outside the visualization community (M).

Each weight can be multiplied by a multiplier a-f

Wt=a(S)+b(N)+c(I)+d(U)+e(C)+f(M)

The importance of a node to the shape of a graph (S) can be pre-calculated based on existing vertex decimation schemes. The contextual importance of a node (I) can be manually assigned or calculated by an existing algorithm depending on the media content of the node. For example, summarization algorithms have been developed for summarizing text-based media while other algorithms have been developed for summarizing video based on closed captions or image recognition. The summarization algorithms can rank different segments of the media to create a hierarchy for summarization. This ranking could be used to calculate the importance of the node (I). The user 305 importance of a node (U) can be calculated dynamically and can be based on profiling the user's browsing pattern of nodes and matching this browsing pattern to other users within the visualization community.

A user can be categorized into groups based on the preference of the user for certain media-organizing characteristics, preferences for specific media, preferences for levels of detail of the media, and/or preferences of associated nodes of the media compared to other users. Based on this categorization a user's likely preference for a particular node can be calculated based on the browsing pattern of other similar users. The community based importance to a node (C) can be collected from user ratings of media that may be associated to a node, the number of ratings for the node, the number of active comments for the node, and/or the general social activity of the node. Metrics based weighting (M) can be based on the popularity of media within a broader community and may include the sales of particular media, the popularity of associated media in other formats, the popularity of associated merchandise, the popularity of physical collectibles associated with the media, the popularity of digital collectibles associated with the media, and/or analytics collected from other systems such as television, radio, broadcast media, theaters, games, computer and device applications, web, and/or advertising networks.

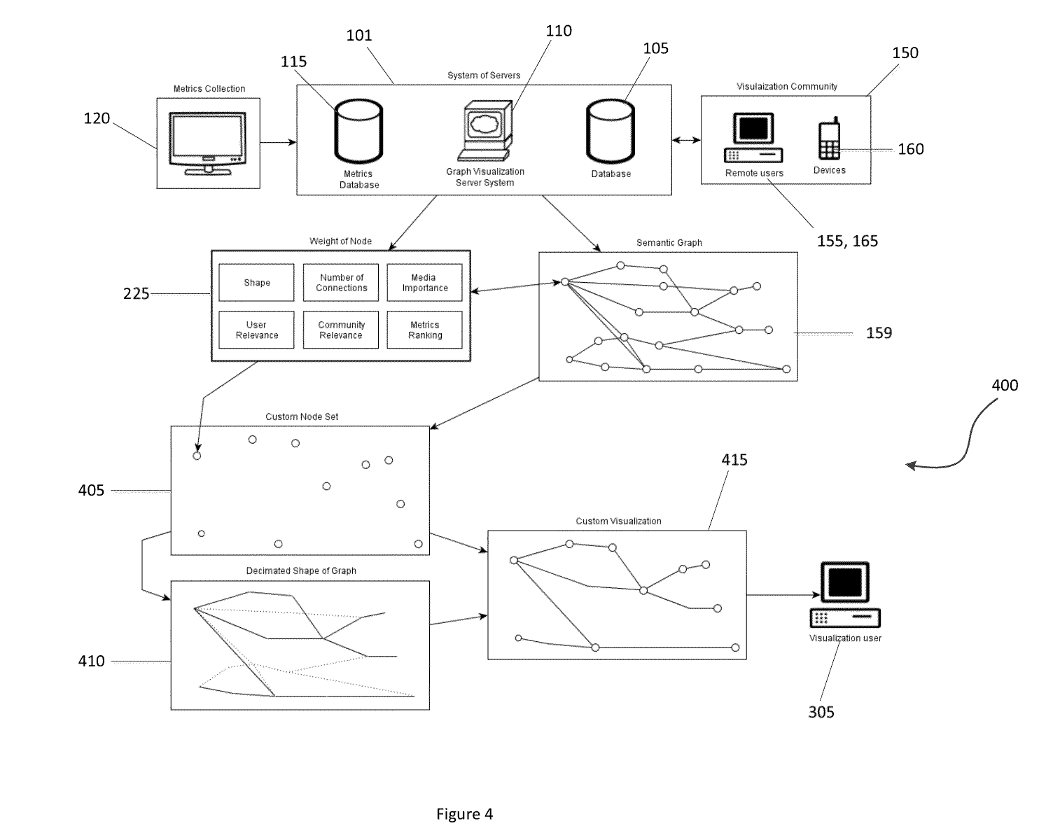

FIG. 4 illustrates a block diagram 400 of a system for ranking and visualizing media organized into a semantic graph 159 at various levels of detail for a single user according to certain embodiments of the present invention. When a user visualizes a semantic graph 159 on a device, the system of servers can stream the shape of the graph, the node locations, and/or node information such that the device can dynamically animate the connections between the nodes at the correct level of detail. The system of servers 101 can calculate the node weights 225 for all nodes (or a subset thereof) based on the initial nodes that may be selected by the user. The system of servers 101 can dynamically generate a set of nodes 405 for each user based on the calculated node weights 225. The system of servers 101 can stream the shape of the semantic graph 159 by using a vertex decimation function that may decimate the vertices representing the full graph shape to a shape that best represents the node set of the user 410. The decimation function can assign a hierarchy to vertices that represent the shape of the graph.

Vertices that may be useful in maintaining the overall shape of the graph may always be streamed, but vertices that are not as important may be streamed as needed for the correct level of detail. The vertex decimation function can preserve the overall shape of the graph at various levels of detail without the associated nodes and media, so that users can see a consistent shape to the graph whether they are zoomed into a magnified section or whether they are looking at a much larger section. The system of servers 101 can separately store and stream the semantic nodes with their associated media to a visualization user 305 in a streamable tree structure 415 that may be dynamically generated such that the depth of the node in the tree may reflect a dynamically calculated visualization weight.

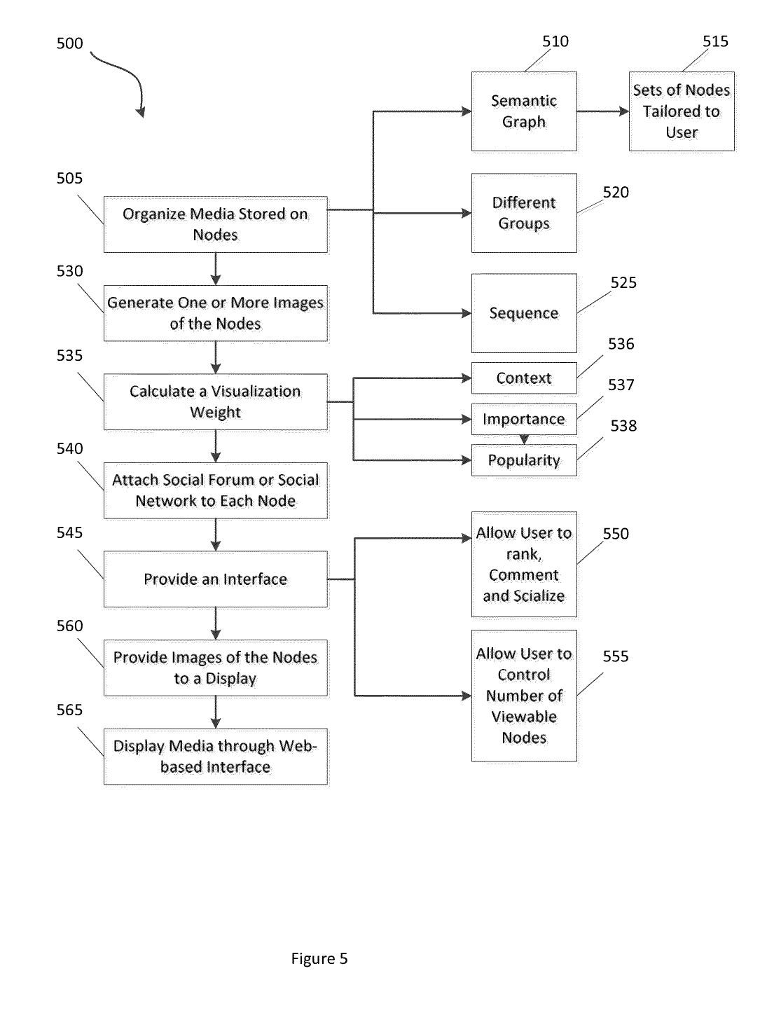

FIG. 5 illustrates a method 500 according to certain embodiments of the present invention. The following procedure provides examples and non-limiting illustrations of certain embodiments of the present invention. At 505, the system of servers can organize media stored on multiple nodes, which can be contextually connected. Alternatively, at 510, the nodes can be organized into a semantic graph at varying levels of complexity such that the contextual relations of the media may be visually highlighted at all levels (or a subset thereof) of detail. Alternatively, the nodes organized in the semantic graph can be further organized, at 515, into various sets of nodes that can be specifically tailored to a user. Alternatively, at 520, the nodes can be organized into different groups based on the content of the media stored on the nodes. Alternatively, at 525, the nodes can be organized in a sequence that correlates to time, distance and/or a progression of each node. It should be noted that the alternatives discussed above can be applied individually or in various combinations with each other according to certain embodiments of the present invention.

The system of servers, at 530, can generate one or more images of the nodes based on at least one parameter related to the user. At 535, the system of servers can calculate a visualization weight for each node of the plurality of nodes. The visualization weight can be calculated, at 536, based on context, at 537, based on importance, or at 538, based on the popularity 538 of each node. At 540, the system of servers can attach a social forum or social network to each node of the plurality of nodes. The social forum and social network can allow the user not only to rate and comment on the stored media, but also to ask or answer questions, friend users, send messages to users, have discussions with users, follow the activity of users, form groups, and/or send announcements to groups of users.

At 545, the system of servers, can provide an interface configured to, at 550, allow the user to rank, comment and socialize with other users around the media of each node. Alternatively, at 545, the system of servers can provide an interface configured to, at 555, allow the user to control the number of viewable nodes. It should be noted that the alternatives discussed above can be applied individually or in combination with each other according to certain embodiments of the present invention.

The system of servers, at 560, can provide one or more images of the nodes to at least one display. The one or more images of the nodes to be displayed can illustrate connections between the displayed nodes. The one or more images of the nodes can also be generated based on datasets selected by the user, a desired level of detail selected by the user, and/or a prioritized set of nodes that are most relevant to the user.

The system of servers, at 565, can display the media through a web-based interface. In certain embodiments of the present invention, the media displayed through the web-based interface can be viewed on a stationary or a portable electronic device. For instance, the media can be displayed through a web-based interface viewed on a computer, a mobile phone, a tablet computer, a device that can connect to a television or monitor, a portable gaming device, secondary devices, projection devices, or other web-enabled device. Such devices can also be used for digital signage and retail displays. However, in other embodiments of the present invention, other stationary or portable electronic devices may be used.

The methods described above can be implemented in hardware alone or by software running on hardware. For example, a computer program product can be encoded with instructions for performing the above-described methods. Likewise, a computer readable medium, such as a non-transitory computer readable medium, can be encoded with instructions that, when executed in hardware, perform the above-described methods.

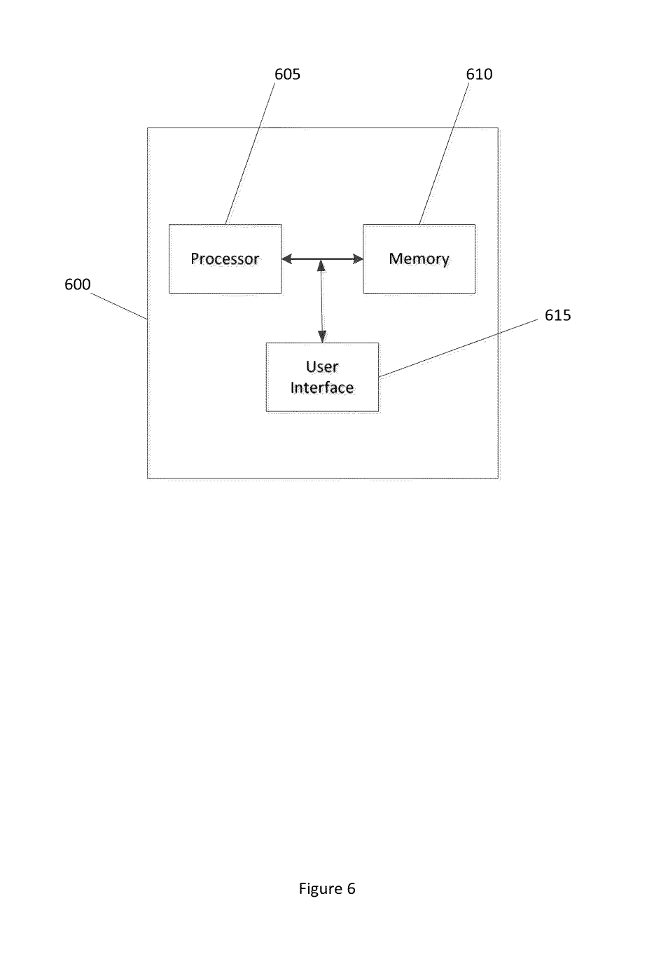

The methods described above can be implemented by an apparatus 600, according to certain embodiments of the present invention and illustrated in FIG. 6. The apparatus may include at least one processor 605. The processor 605 can be any type of general or specific-purpose processor. While a single processor 605 is shown in FIG. 6, multiple processors can be utilized according to other embodiments of the present invention. Processor 605 can also include one or more of general-purpose computers, special-purpose computers, microprocessors, digital signal processors (DSPs), field-programmable gate arrays (FPGAs), application-specific integrated circuits (ASICs), and/or processors based on a multi-core processor architecture, as examples.

The apparatus 600 can also include at least one memory 610. The memory 610 may include computer program instructions or computer code. The memory 610 can be one or more memories of any type suitable to the local application environment, and can be implemented using any suitable volatile or nonvolatile data storage technology such as semiconductor-based memory device, a magnetic memory device and system, an optical memory device and system, fixed memory, and removable memory. For example, memory 610 may include any combination of random access memory (RAM), read only memory (ROM), static storage such as magnetic or optical disk, hard disk drive (HDD), or any other type of non-transitory machine or computer readable media. The instructions stored in memory 610 can include program instructions or computer program code that, when executed by processor 605, enable the apparatus 600 to perform tasks as described herein.

The apparatus 600 can also include a user interface 615. The user interface 615 of FIG. 6 can be implemented by software stored in memory 610 or other computer-readable or tangible medium, and executed by processor 605. In other embodiments of the present invention, the functionality may be performed by hardware (e.g., through the use of an ASIC, a programmable gate array (PGA), an FPGA or any combination of hardware and software).

While the apparatus 600 shown in FIG. 6 is illustrated as a single device, the apparatus may be implemented in a distributed way using a plurality of separate servers or other computing devices that communicate with one another and perform various individual functions, as described above. Each of these servers or other computing devices may have its own memory, processor, software, communications hardware, and the like.

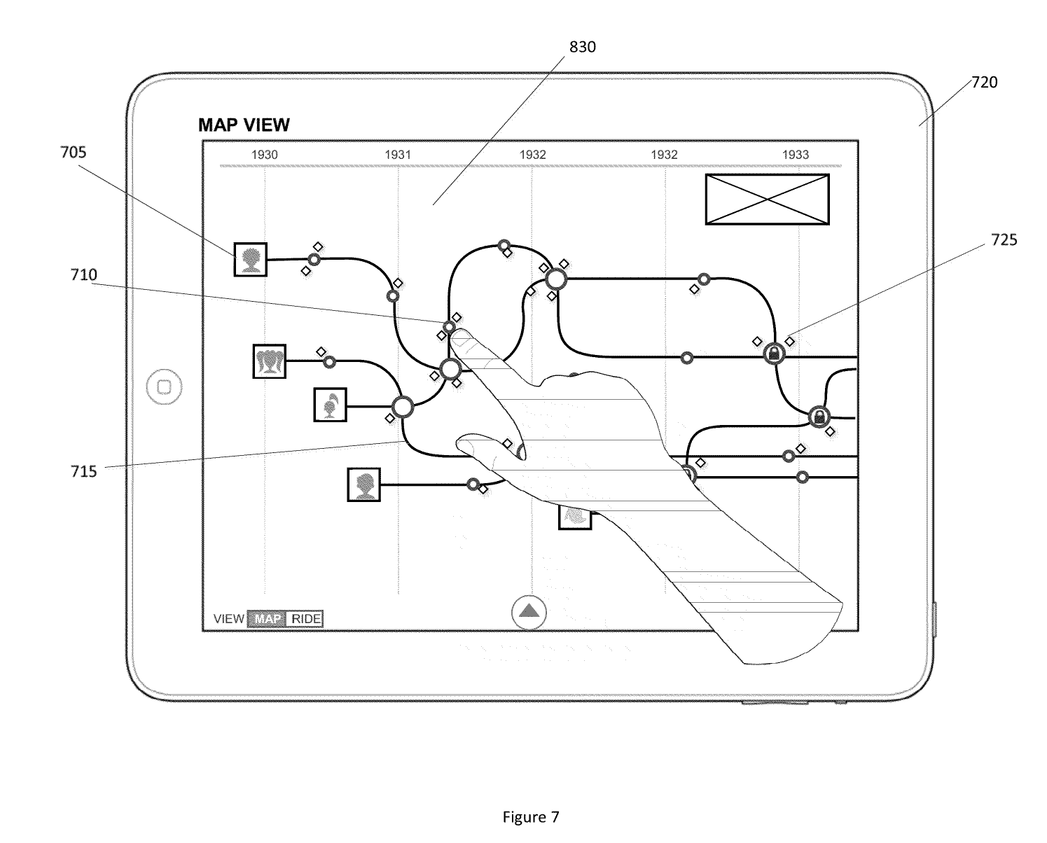

FIG. 7 illustrates an exemplary implementation of certain embodiments of the present invention as a mobile tablet application operated on a mobile tablet 720, in a two-dimensional view of a node graph 830. However, in other embodiments, the application can be operated on any of the stationary or portable electronic devices previously described herein, or the like. More specifically, FIG. 7 illustrates one of two types of streams. A first type of stream may be chronological time with intersecting media elements. A second type of stream may be narrative time, showing how characters intersected in “story time” over the course of, for example, one or more movies.

FIG. 7 also illustrates a label 705 that can be included within the interconnected media. The label 705 can represent a character to show that the stream of the timeline relates to him or her. The interconnected media can also include multiple nodes 710 that a user can interact with by tapping/touching the node. For instance, the interconnected media may include, for example, nodes 710 that can represent various media items.

Nodes 710 can be arranged along lines 715. Lines 715 can show relationships between media content and how the nodes are connected relative to each other. Examples of arrangements include, but are not limited to: arrangement according to character intersections across media over real time as shown by the lines, spacing, and grouping of nodes; arrangements according to character intersections over narrative time within media as shown by lines, spacing, and grouping of nodes 715; arrangements according to other metadata, or client or user-generated criteria, such as “villains,” “heroes,” “gender,” “age,” etc.; arrangements according to user-generated criteria, such as “favorites,” “order watched,” “my friends' favorites,” and so on.

Nodes 710 can also be surrounded with small avatars 725. Avatars 725 may represent users gathering around popular content, which is aggregated and cached over a window of time such as, for example, twenty-four hours.

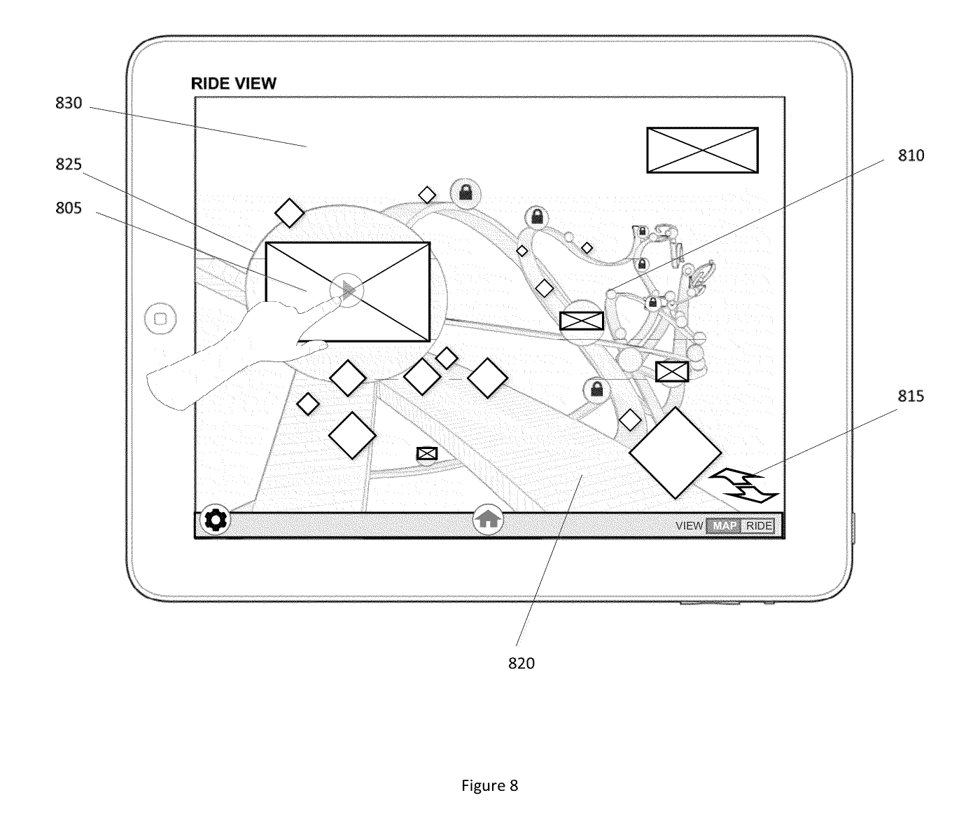

FIG. 8 illustrates an exemplary implementation of certain embodiments of the present invention as a mobile tablet application, in a three-dimensional “ride” view of the node graph 830 that simplifies viewing for users as one node at a time. However, as mentioned above, in other embodiments, the application can be operated on any of the stationary or portable electronic devices previously described herein, or the like. In this view, users can, at 805, preview the content contained in each node 825. Users can also touch nodes in a distance 810 along an interconnected pathway 820 between multiple nodes to “fast forward” or more quickly move along interconnected pathways 820 from one node to another. Users can also advance from node-to-node with buttons 815, or via a sliding motion, such as, for example, sliding fingers in an up/down motion, or a pinch/drag for more exploration.

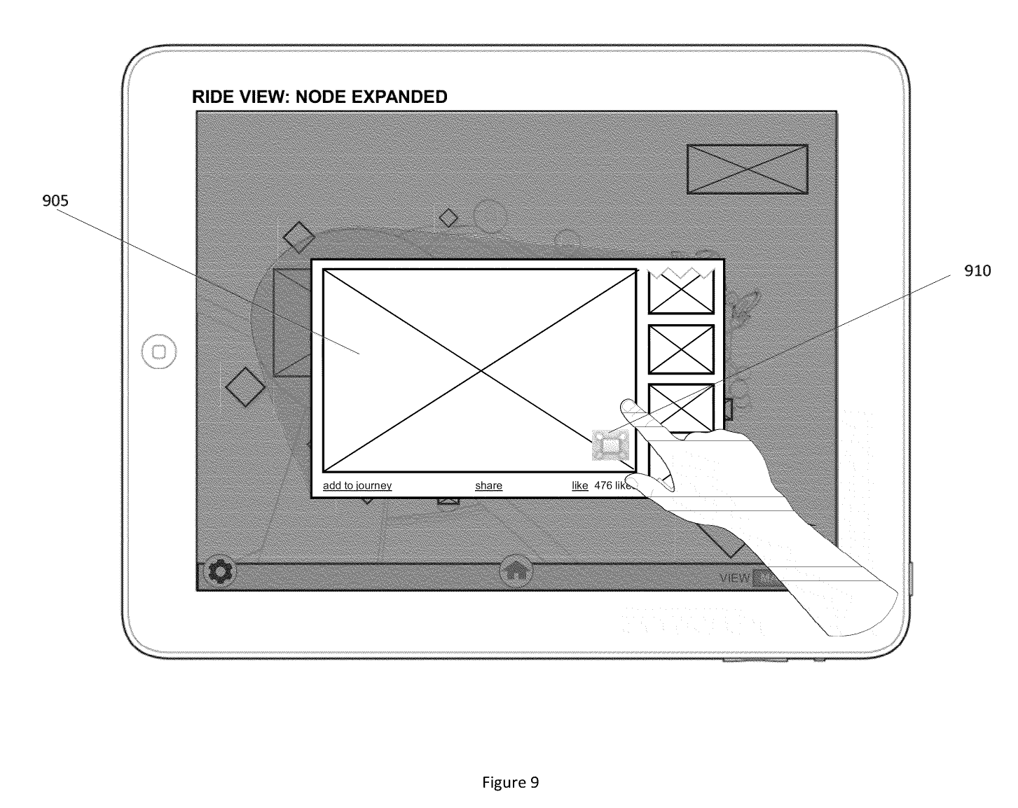

FIG. 9 illustrates an exemplary implementation of certain embodiments of the present invention as in FIG. 8 with simplified user choices for navigating the graph 830. For instance, the graph 830 may be navigated in various manners, such as, for example, forward or backwards, or following a character, plot, or story element, or other nodes that relate to metadata relating to, or connecting to this node.

Other navigation options can also be available to the user. For example, in the “ride” view of the node graph 830, after a user taps or touches node 825 along the interconnected pathway 820, the node 825 may be expanded to allow the user to view the contents contained within the node 825. The contents of the node 825 may include various forms of media, such as, for example, video 905 and/or various forms of media as previously described herein, or the like. If the media content within the node 825 contains video 905, upon expansion of node 825, video 905 may automatically play. The video 905 may also be expanded to full screen by tapping/touching button 910. In other embodiments of the present invention, the node 825 may automatically cycle through any additional media contained therein.

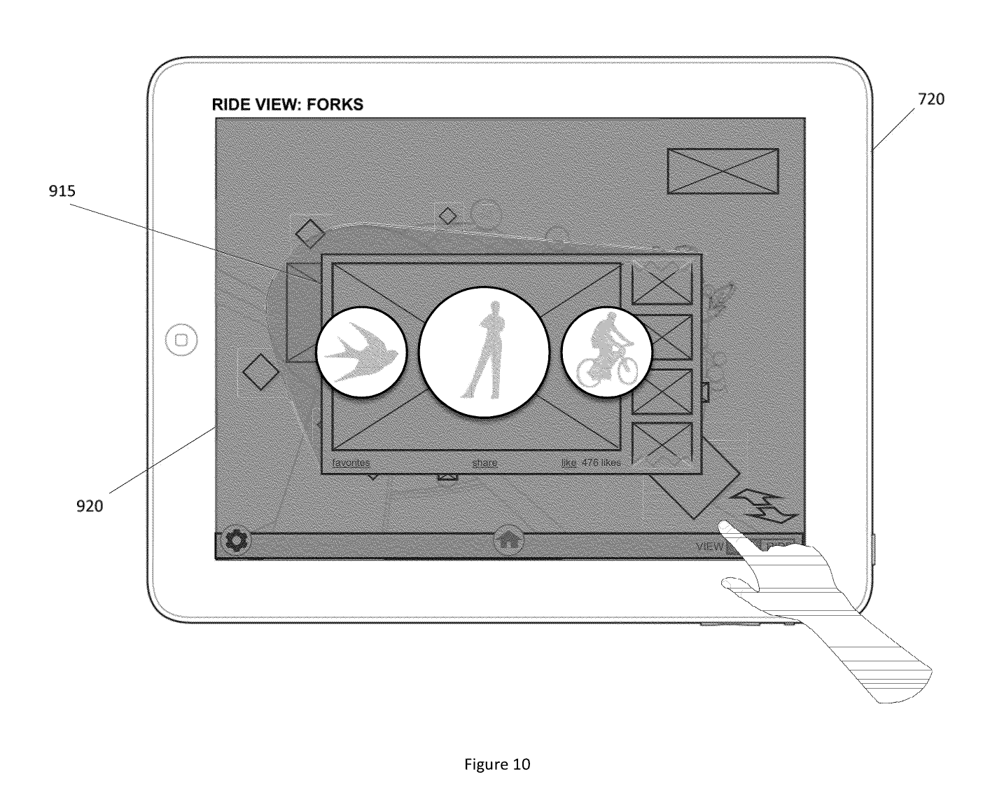

FIG. 10 illustrates another exemplary implementation of certain embodiments of the present invention as in FIG. 8 with simplified user choices for navigating the node graph 830. For instance, if a user reaches a “fork” associated with, for example, at least one of a character, a story, a plot, alternate timelines, alternate media, or the like, along the interconnected pathway 820 that leads to multiple directions for the user to navigate in the graph 830, a window 915 may pop up on the display 920 of the tablet 720. The window 915 may display information that allows a user to choose a direction to proceed in along the interconnected pathway 820. For example, the information may include character information that provides the user with options of which character to follow. The information may also contain any of the other various forms of media content previously described herein.

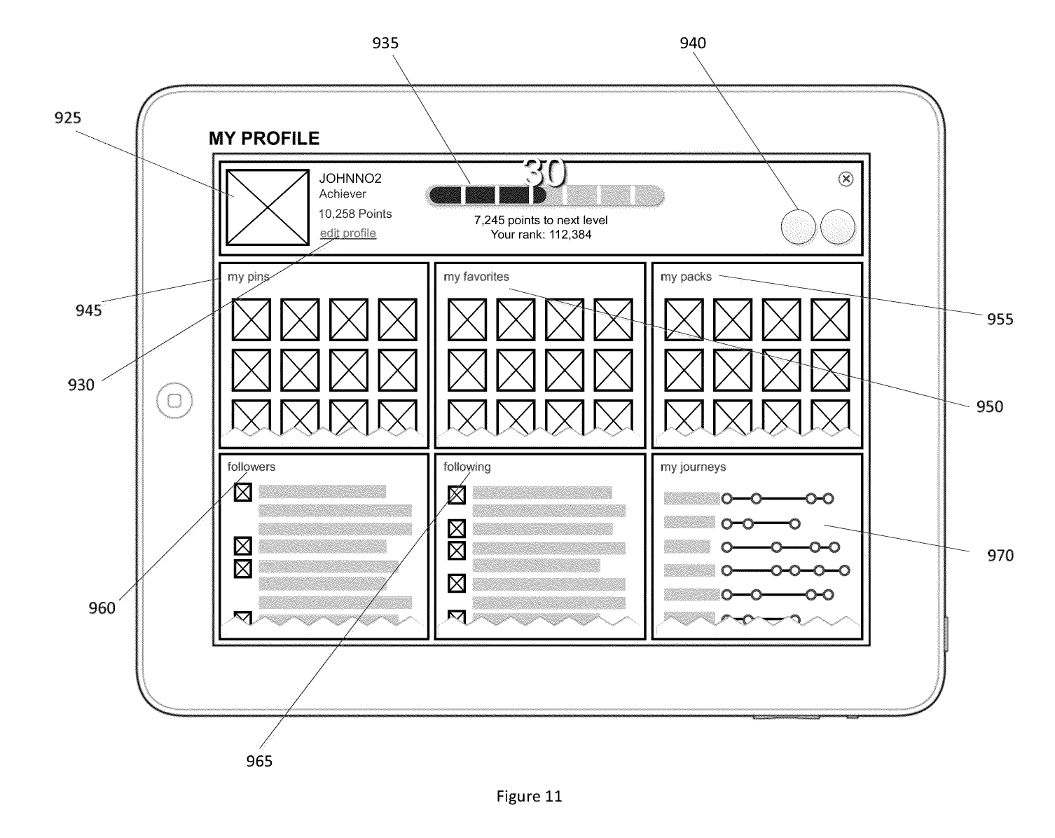

FIG. 11 illustrates an exemplary implementation of certain embodiments of the present invention as in FIG. 7 with a view of a user's profile. The profile may include achievements, status, social connections favorite media, purchases, progress, and the like. If a profile has not been setup, a button (not shown) within region 925 may appear so that a user can tap/touch the button to begin creating a new user profile. Once created, the profile may be edited by using link 930. Editing the profile via link 930 can also allow the user to create a username and associate the user profile with a picture of the user's choosing. If a username has not been created, a default username can be automatically assigned to the user. The chosen username and picture can be attached to various social networks to identify the user. To identify which social networks are supported, the user profile may include social network icons 940 that inform the user of the supported social media accounts.

Monitoring of the user profile may also be available. For example, the user can monitor profile status via status bar 935. Status information may include, for example, the number of points the user needs to reach the next level, the user's rank, and the like.

The user profile may also include various other information relevant to the user. For example, the profile may include a pins portion 945 that can correspond to the journeys or pathways 820, characters, and/or various forms of media content as previously described herein that the user is interested in, would like to follow, and/or would like to share. The profile may also include a favorites portion 950 that can correspond to nodes that the user has “liked.” The profile may also include a packs portion 955 that can correspond to types of media content liked by the user or that may be most relevant to the user. The profile may also include follower information 960 of other users that may be following the user, other users that the user is following 965, and journeys or pathways 970 that may include various node networks that the user has explored and/or the user has created, which can be optionally shared to a community.

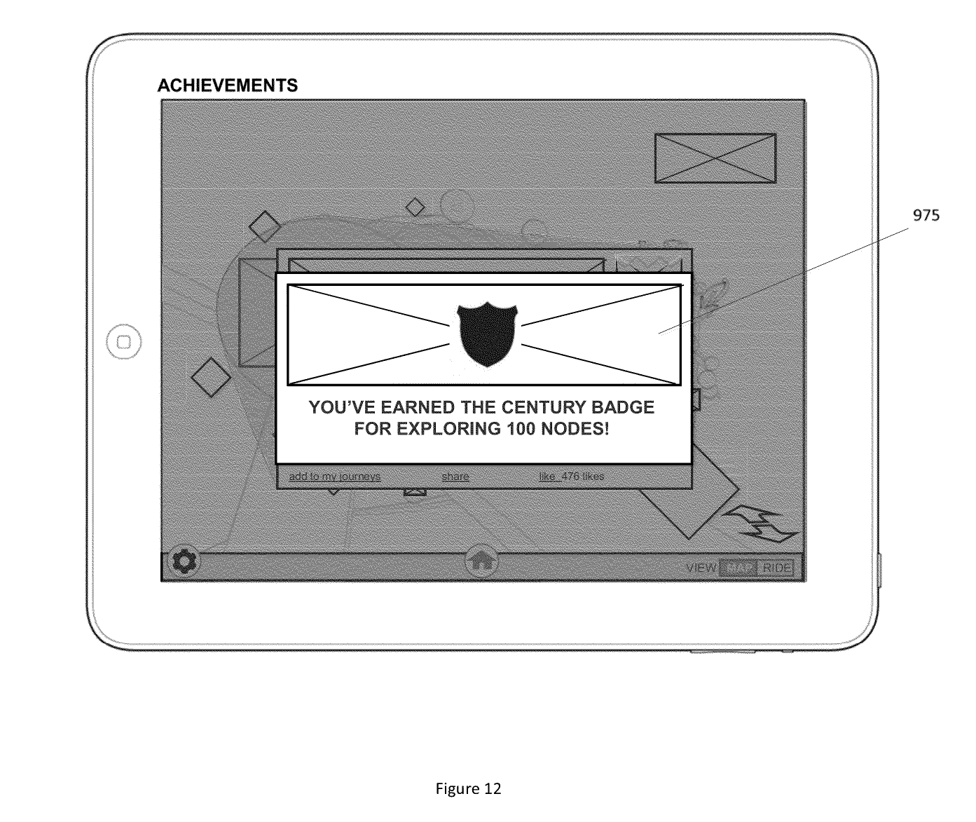

FIG. 12 illustrates an exemplary implementation of certain embodiments of the present invention as in FIG. 7 in which the user can achieve a reward based on exploration of or participation in various nodes in the node graph 830. For example, while a user explores the nodes within the node graph 830, the user can receive digital achievements 975 upon reaching a certain point or exploration milestone.

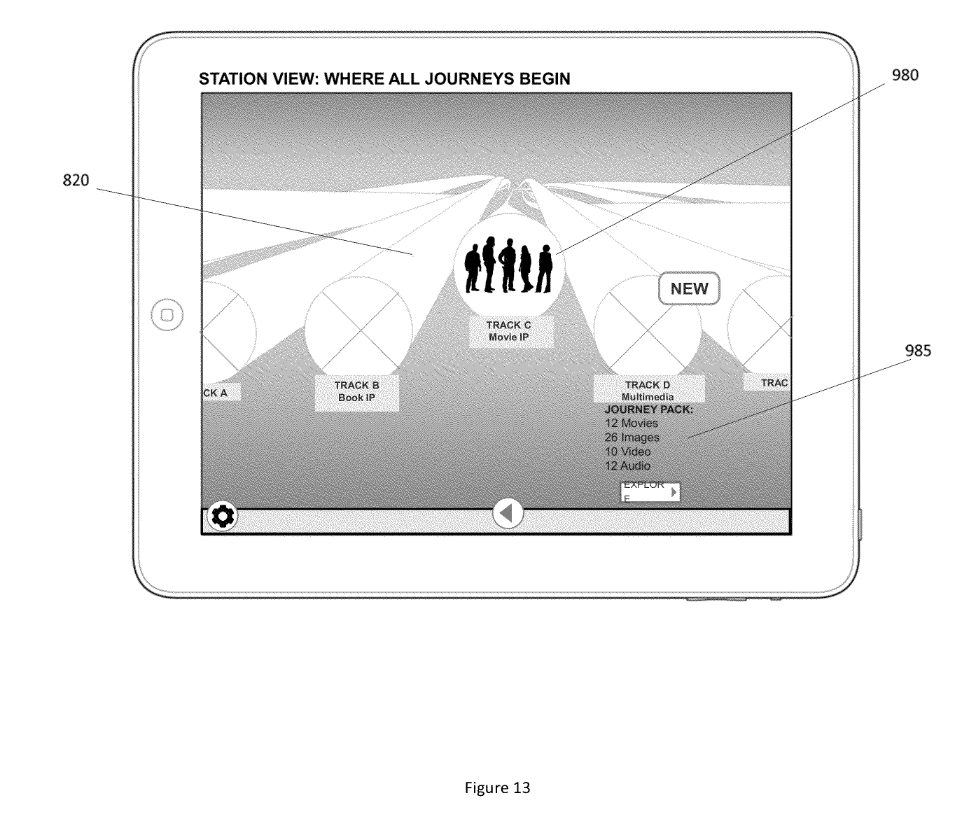

FIG. 13 illustrates an exemplary implementation of certain embodiments of the present invention as in FIG. 7 in which a user can purchase various media items, subscriptions, or virtual currency, and the like, to buy media. These items can be viewed at area 985 of the node graph 830 in a “station” view. Area 985 may also show highlights of new featured content, and may indicate how much content is inside a particular interconnected pathway 820. FIG. 13 also illustrates a “station” view of where all journeys or interconnected pathways 820 can begin that can allow the user to begin following a particular type of media content along a particular interconnected pathway 820.

The user may also shift from one interconnected pathway 820 to another in a left or right direction. The user may also be able to view key content 980 contained within a particular interconnected pathway 820 and select a pathway 820 to follow by touching or tapping on the desired pathway 820.

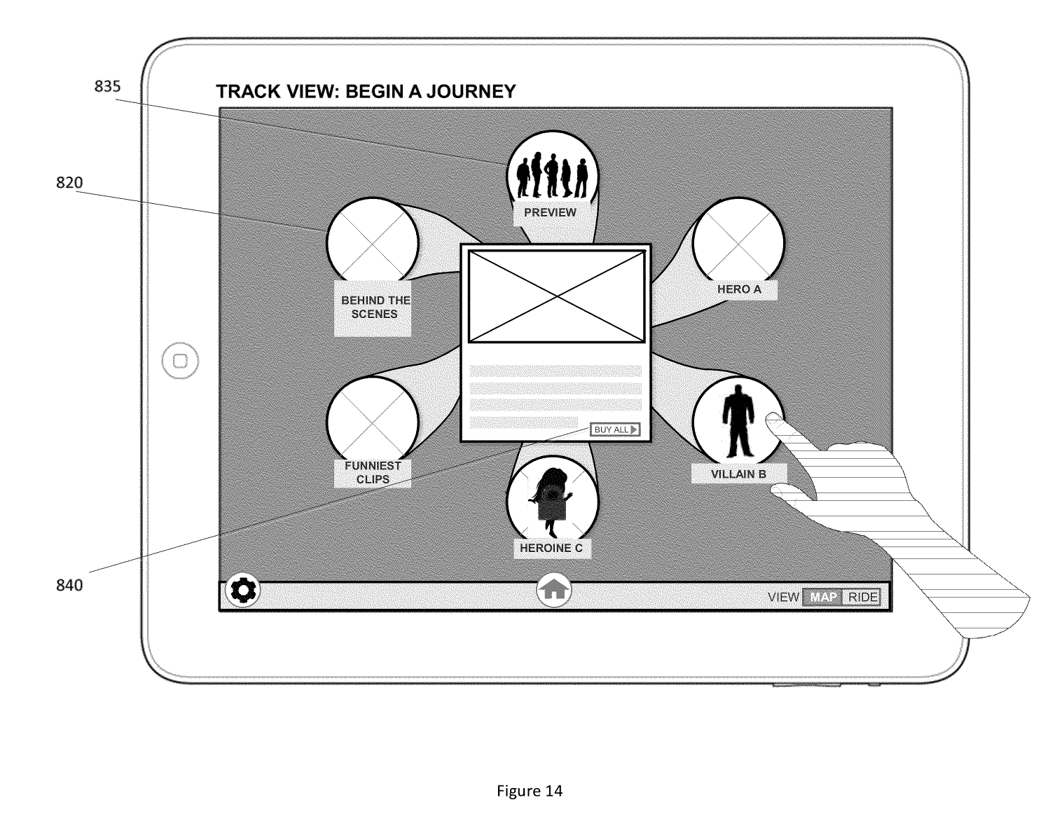

FIG. 14 illustrates another exemplary implementation of certain embodiments of the present invention as in FIG. 7 in which a user can purchase media items, subscriptions, virtual currency or the like to buy media. Prior to purchasing media items associated with a particular pathway 820, users can preview 835 the contents of each pathway 820. Each pathway 820 may have at least one free populated preview of what will be found in the rest of the pathway. A user can also touch/tap on a pathway 820 to zoom in along the path in 3D. Each pathway 820 can be purchased individually at a low price point or as a group for a single discounted price by touching/tapping on the “buy all” icon 840. In other embodiments, some pathways 820 may be viewed free of charge to viewers in an effort to attract more viewers, subscribers, and/or ticket buyers.

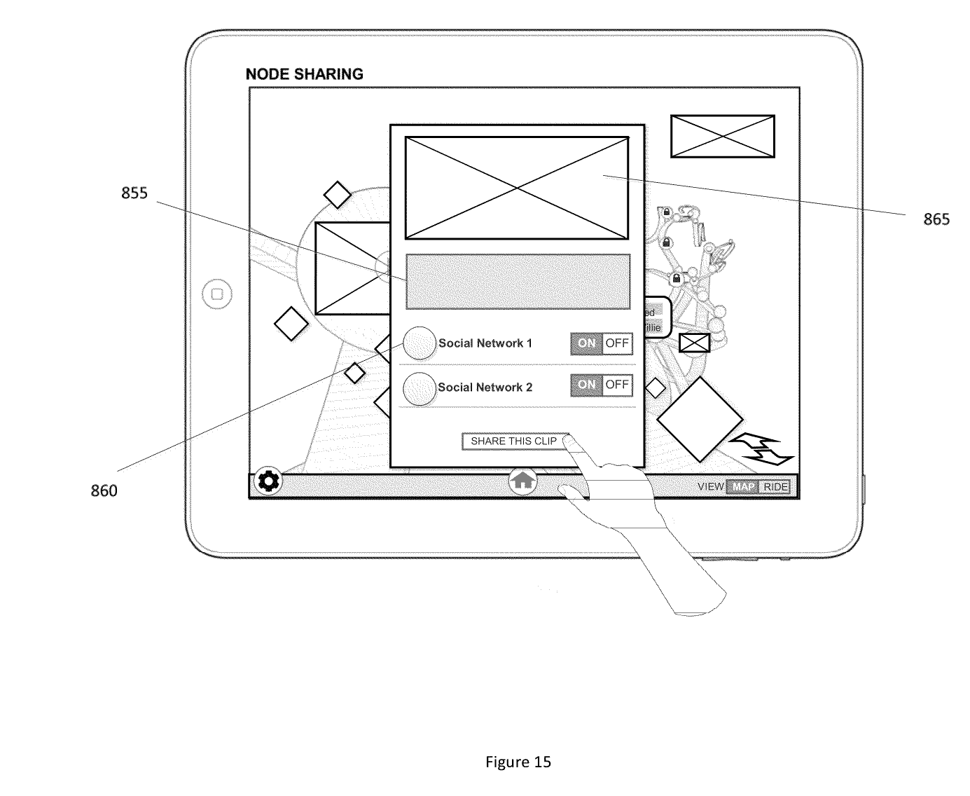

FIG. 15 illustrates an exemplary implementation of certain embodiments of the present invention as in FIG. 7 in which a user can receive notifications of social activity associated with nodes, and share content with external social networks. For example, as shown in FIG. 15, a user can include a user-written message 855 that can be added and/or published to a user's social networking account(s). The user may also have the ability to select which social network(s) 860 that the user would like to upload the media content associated with a particular node along with the user-written message 855. That is, the user can choose to share the media content that can also include individual node networks created by the user, and user-written message 855 on more than one social network. Prior to sharing the media content and/or user-written message 855, the user can view a preview 865 of the media content, as, for example, an image.

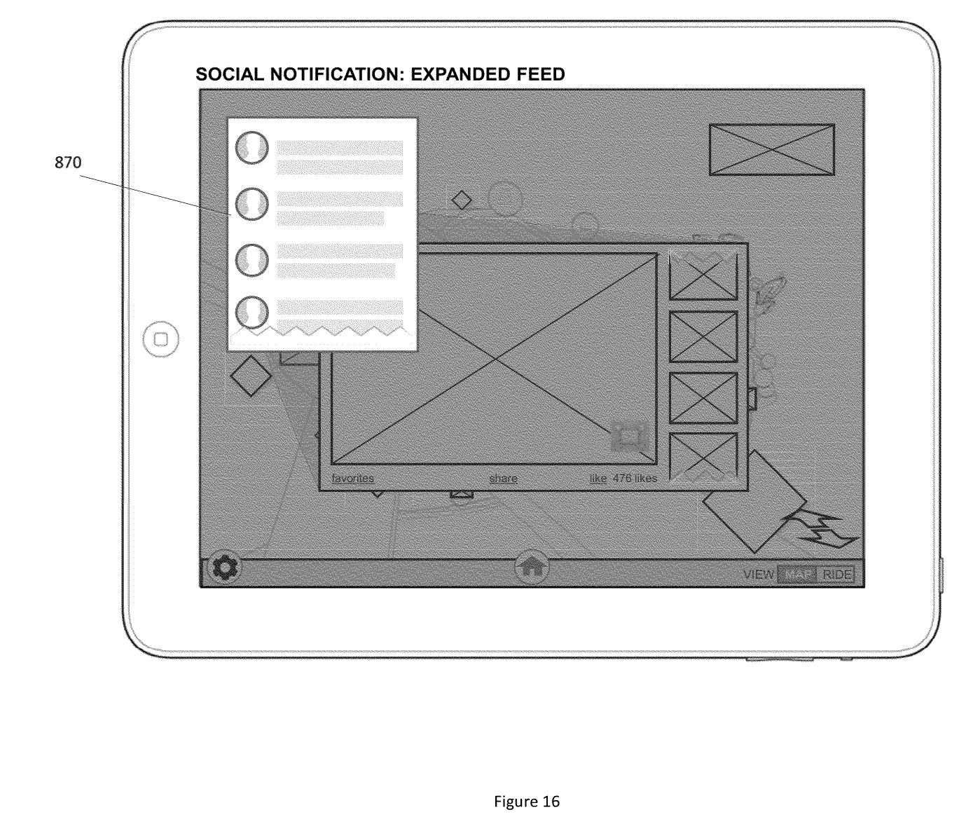

FIG. 16 is another exemplary implementation of certain embodiments of the present invention as in FIG. 7 in which a user can receive notifications of social activity associated with nodes, and share content with external social networks. For example, a user can touch/tap on a node 825 along an interconnected pathway 820 to view the contents contained within the node 825 in an expanded view. Within the expanded view of the node 825, the user can further touch/tap a message associated with particular media content within the node 825 to expand into a feed 870 containing notifications, comments, and the like, of other users.

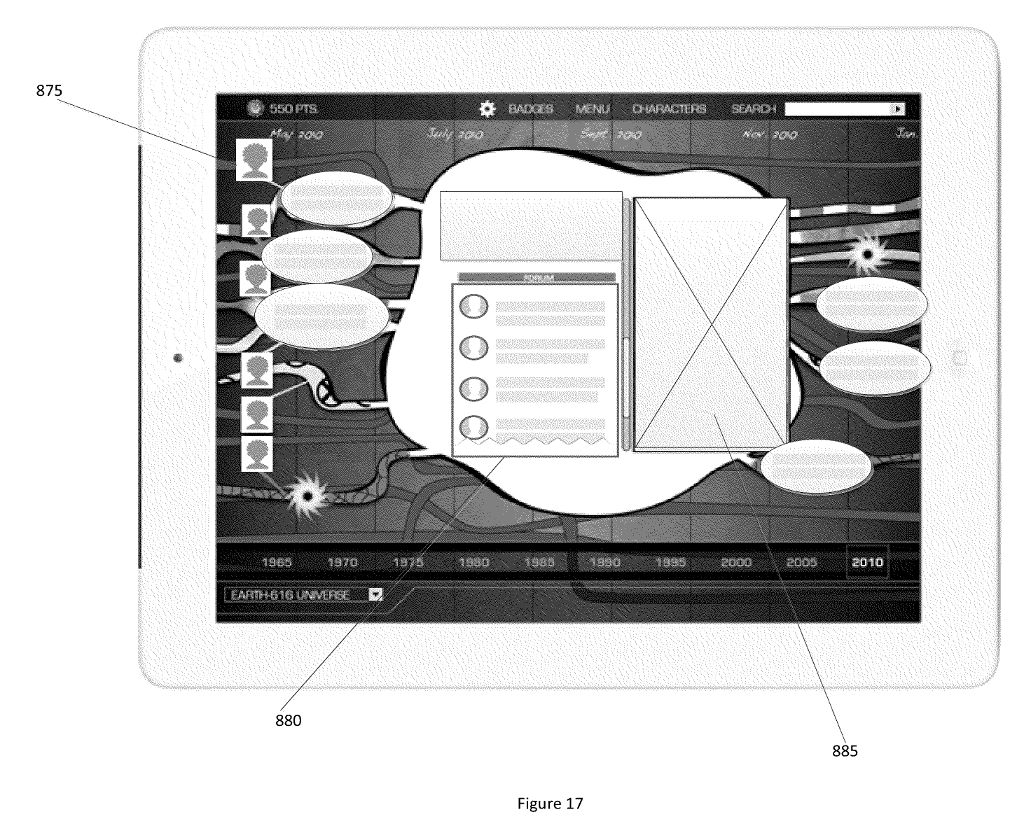

FIG. 17 is an exemplary implementation of certain embodiments of the present invention as in FIG. 7 in which users can engage in social conversations with other users associated with nodes, and share content with external social networks. For example, users can track the storylines of various characters 875, view the storylines in a chronological timeline stream, and participate in a social forum 880 around each node regarding a particular media item 885.

The described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims

We claim:

1. A method comprising:
organizing media stored on a plurality of nodes, the media being contextually connected;
generating one or more images of the nodes based on at least one parameter related to a user; and
providing the one or more images of the nodes to at least one display,
wherein the one or more images of the nodes to be displayed illustrate connections between the displayed nodes, and
the one or more images of the nodes are generated based on datasets selected by the user, a desired level of detail selected by the user, or a prioritized set of nodes that are most relevant to the user.

2. The method of claim 1, further comprising organizing the nodes into a semantic graph.

3. The method of claim 1, further comprising calculating a visualization weight for each node of the plurality of nodes based on context, importance, and popularity.

4. The method of claim 1, further comprising organizing the nodes into different groups based on the content of the media stored on the nodes.

5. The method of claim 1, further comprising organizing the nodes in a sequence that correlates to time, distance or a progression.

6. The method of claim 1, further comprising organizing the nodes in a sequence that correlates to character, plot, story relationships, other metadata derived relationships, user or customer-curated criteria, or any criteria generated automatically via metadata analysis, or manually created by content developers or end users.

7. The method of claim 1, further comprising displaying the media associated with nodes through a web-based interface viewed on a stationary or portable electronic device.

8. The method of claim 1, further comprising displaying the media through a web-based interface viewed on a stationary or portable electronic device.

9. The method of claim 1, further comprising attaching a social forum or social network to each node of the plurality of nodes.

10. The method of claim 1, further comprising providing an interface configured to allow the user to rank, comment and socialize with other users around the media of each node.

11. The method of claim 1, further comprising providing an interface configured to allow the user to control the number of viewable nodes.

12. The method of claim 1, further comprising generating a set of nodes into the semantic graph that is specifically tailored to the at least one parameter related to the user.

13. The method of claim 1, further comprising displaying one selected node at a time, and providing the user with a simplified set of choices for node exploration,
wherein the node exploration comprises forward and backward navigation options, or choices between metadata forks associated with at least one of a character, a story, a plot, an alternate timeline, or alternate media.

14. The method of claim 1, wherein the user can purchase individual media items, television series, subscribe to media subscriptions, or purchase virtual currencies towards credits to purchase media.

15. The method of claim 1, wherein the user can create individual node networks, and optionally share them to a community.

16. An apparatus, comprising:
at least one processor; and
at least one memory including computer program code,
wherein the at least one memory and the computer program code are configured to, with the at least one processor, cause the apparatus at least to:
generate one or more images of the nodes based on at least one parameter related to a user; and
provide the one or more images of the nodes to at least one display,
wherein the one or more images of the nodes to be displayed illustrate connections between the displayed nodes, and
the one or more images of the nodes are generated based on datasets selected by the user, a desired level of detail selected by the user, or a prioritized set of nodes that are most relevant to the user.

17. The apparatus of claim 16, wherein the at least one memory and the computer program code are further configured to, with the at least one processor, cause the apparatus at least to organize the nodes into a semantic graph.

18. The apparatus of claim 16, wherein the at least one memory and the computer program code are further configured to, with the at least one processor, cause the apparatus at least to calculate a visualization weight for each node of the plurality of nodes based on context, importance, and popularity.

19. The apparatus of claim 16, wherein the at least one memory and the computer program code are further configured to, with the at least one processor, cause the apparatus at least to organize the nodes into different groups based on the content of the media stored on the nodes.

20. The apparatus of claim 16, wherein the at least one memory and the computer program code are further configured to, with the at least one processor, cause the apparatus at least to organize the nodes in a sequence that correlates to time, distance or a progression.

21. The apparatus of claim 16, wherein the at least one memory and the computer program code are further configured to, with the at least one processor, cause the apparatus at least to organize the nodes in a sequence that correlates to character, plot, story relationships, other metadata derived relationships, user or customer-curated criteria, or any criteria generated automatically via metadata analysis, or manually created by content developers or end users.

22. The apparatus of claim 16, wherein the at least one memory and the computer program code are further configured to, with the at least one processor, cause the apparatus at least to display the media associated with nodes through a web-based interface viewed on a stationary or portable electronic device.

23. The apparatus of claim 16, wherein the at least one memory and the computer program code are further configured to, with the at least one processor, cause the apparatus at least to display the media through a web-based interface viewed on a stationary or portable electronic device.

24. The apparatus of claim 16, wherein the at least one memory and the computer program code are further configured to, with the at least one processor, cause the apparatus at least to attach a social forum or social network to each node of the plurality of nodes.

25. The apparatus of claim 16, wherein the at least one memory and the computer program code are further configured to, with the at least one processor, cause the apparatus at least to provide an interface configured to allow the user to rank, comment and socialize with other users around the media of each node.

26. The apparatus of claim 16, wherein the at least one memory and the computer program code are further configured to, with the at least one processor, cause the apparatus at least to provide an interface configured to allow the user to control the number of viewable nodes.

27. The apparatus of claim 16, wherein the at least one memory and the computer program code are further configured to, with the at least one processor, cause the apparatus at least to generate a set of nodes into the semantic graph that is specifically tailored to the at least one parameter related to the user.

28. The apparatus of claim 16, wherein the at least one memory and the computer program code are further configured to, with the at least one processor, cause the apparatus at least to display or otherwise emphasize one selected node at a time, and providing the user with a simplified set of choices for node exploration,
wherein the node exploration comprises forward and backward navigation options, or choices between metadata forks associated with at least one of a character, a story, a plot, an alternate timeline, or alternate media.

29. The apparatus of claim 16, wherein the at least one memory and the computer program code are further configured to, with the at least one processor, cause the apparatus at least to allow the user to purchase individual media items, television series, subscribe to media subscriptions, or purchase virtual currencies towards credits to purchase media.

30. The apparatus of claim 16, wherein the at least one memory and the computer program code are further configured to, with the at least one processor, cause the apparatus at least to allow the user to create individual node networks, and optionally share them to a community.

31. A non-transitory computer-readable medium encoded with instructions that, when executed in hardware, perform a process, the process comprising:
organizing media stored on a plurality of nodes, the media being contextually connected;
generating one or more images of the nodes based on at least one parameter related to a user; and
providing the one or more images of the nodes to at least one display,
wherein the one or more images of the nodes to be displayed illustrate connections between the displayed nodes, and
the one or more images of the nodes are generated based on datasets selected by the user, a desired level of detail selected by the user, or a prioritized set of nodes that are most relevant to the user.
